(19) United States
(12) Patent Application Publication
(10) Pub. No.: US 2016/0119940 A1
(43) Pub. Date: Apr. 28, 2016

(54) METHOD AND BS FOR IDENTIFYING UE TRANSMITS SR, AND METHOD AND UE FOR TRANSMITTING SR TO BS

(71) Applicant: TELEFONAKTIEBOLAGET L M ERICSSON (PUBL), Stockholm (SE)

(72) Inventors: Jun WANG, Nanjing (CN); Yingde LIU, Nanjing (CN); Shan LI, Nanjing (CN)

(21) Appl. No.: 14/786,813

(22) PCT Filed: May 15, 2013
(86) PCT No.: PCT/CN2013/075635

§ 371 Date: Oct. 23, 2015

(51) Int. Cl. H04W 72/12; H04L 1/18

(52) U.S. Cl. CPC H04W 72/12; H04W 72/1289; H04L 1/1812

(57) ABSTRACT

The present disclosure relates to a method used in a BS for identifying that a UE transmits a SR, and an associated BS. The method includes: determining a first Walsh code for the UE transmitting HARQ feedback based on a CCE index allocated to the UE; transmitting to the UE an indication indicating a second Walsh code for the U E transmitting the HARQ feedback, the second Walsh code being different from the first Walsh code; receiving the HARQ feedback from the U E; and identifying that the UE transmits the SR, if the received HARQ feedback uses the second Walsh code. The present disclosure also relates to a method used in a UE for transmitting a SR to a BS, and an associated UE.

### TECHNICAL FIELD

The technology presented in this disclosure generally relates to radio communication networks. More particularly, the present disclosure relates to a method used in a Base Station (BS) for identifying that a User Equipment (UE) transmits a Scheduling Request (SR) and an associated BS, and to a method used in a UE for transmitting a SR to a BS and an associated UE.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

In general, Examples of UpLink (UL) control signalling in mobile communications systems may include Hybrid Automatic Repeat Request (HARQ) Acknowledgments (also referred to as HARQ feedback, including ACK/NACK) for Down Link (DL) data packets, Channel Quality Indicators (CQIs), and MIMO feedback (such as Rank Indicator (RI) or Precoding Matrix Indicator (PMI)) for DL transmissions. Scheduling Requests (SRs) for UL transmissions also fall into this category.

The mapping between the PUCCH format and the Uplink Control Information (UCI) supported in LTE is shown in Table 1.

TABLE 1
Supported UCI formats on PUCCH
PUCCH Format Uplink Control Information (UCI)

| | |
|---|---|
| Format 1 | Scheduling request (SR) (unmodulated waveform) |
| Format 1a | 1-bit HARQ ACK/NACK with/without SR |
| Format 1b | 2-bit HARQ ACK/NACK with/without SR |
| Format 2 | CQI (20 coded bits) |
| Format 2a | CQI and 1-bit HARQ ACK/NACK (20 + 1 coded bits) |
| Format 2b | CQI and 2-bit HARQ ACK/NACK (20 + 2 coded bits) |

In TDD-LTE UL, SR and HARQ acknowledgement are transmitted using PUCCH 1/1a/1b format, which are respectively located at different discontinuous physical RB resources.

However, when multiplexing HARQ feedback and SR (also referred to HARQ&SR multiplexing), due to the Single Carrier constraint which requests the UL transmission must be carried on continuous RB resources, the SR and HARQ must not be sent separately at their respective RB resources. Instead, only one RB resource can be used for UL transmission, so one signal need be hidden implicitly into the other one.

On one hand, each HARQ feedback is typically composed by one QPSK symbol, which is equivalent to 2 bits of information corresponding to two separate DL code words. Hence, there is no extra more space to accommodate an indication for SR.

On the other hand, not only the HARQ feedback itself, but also the original HARQ feedback position is actually the most important factor for BS to interpret the HARQ feedback during bundling TTI window. Then, the existing solution of hiding HARQ feedback into SR will result in information loss of the original HARQ feedback position, thereby BS cannot guarantee correct interpretation of the HARQ feedback regardless of how many Downlink Assignment Index (DAI) indicators are added into downlink control information.

Then, one issue is how to carry SR information on the HARQ feedback without losing HARQ feedback position and without breaking the single-carrier constraint comes out.

CN102215595A discloses a method of multiplexing HARQ feedback and SR by moving SR to HARQ feedback through the 4^{th} unused Walsh code under each ZC sequence. However, the method described therein can't be applied in the real deployment due to the following defects:
Only the 4^{th} Walsh code under each ZC sequence is allowed. So, when more than one UE under a same ZC sequence need to send a SR simultaneously, the method only allows for one UE to use the unused Walsh code even if the other Walsh codes are still unused.
It lacks an effective method for BS to notify UE if the 4^{th} Walsh code can be used or not. Once more than one UE under the same ZC sequence need to send a SR simultaneously, all of the UEs will compete for the 4^{th} Walsh code simultaneously. This may result in confliction of HARQ feedbacks from different UEs on the 4^{th} Walsh code.

### SUMMARY

It is in view of the above considerations and others that the various embodiments of the present technology have been made.

According to a first aspect of the present disclosure, there is proposed a method used in a BS for identifying that a UE transmits a SR. The method includes a step of determining a first Walsh code for the UE transmitting HARQ feedback based on a Control Channel Element (CCE) index allocated to the UE. The method further includes a step of transmitting to the UE an indication indicating a second Walsh code for the UE transmitting the HARQ feedback. The second Walsh code is different from the first Walsh code. The method further includes receiving the HARQ feedback from the UE. Then the method further includes identifying that the UE transmits the SR, if the received HARQ feedback uses the second Walsh code.

Preferably, the method further includes a step of identifying that the UE does not transmit the SR, if the received HARQ feedback uses the first Walsh code.

Preferably, the method further includes a step of selecting the second Walsh code from one or more Walsh codes within the same Physical Resource Block (PRB) as that of the first Walsh code. Said one or more Walsh codes are not occupied by any UE's HARQ feedback.

Preferably, the indication is transmitted in Downlink Control Information (DCI) for the UE.

Preferably, before determining the first Walsh code, the method further comprises: if two consecutive CCEs have been allocated to other two UEs, one or both of which are allowed to transmit a SR at the same UL subframe as the HARQ feedback, allocating to the UE CCEs inconsecutive with the two consecutive CCEs.

According to a second aspect of the present disclosure, there is proposed a method used in a UE for transmitting a SR to a BS. The method includes a step of determining a first Walsh code for transmitting HARQ feedback based on a CCE index allocated to the UE. The method further includes a step of receiving from the BS an indication indicating a second Walsh code for the UE transmitting the HARQ feedback. The second Walsh code is different from the first Walsh code. The method further includes a step of transmitting the HARQ feedback to the BS using the second Walsh code to indicate that the UE transmits the SR.

Preferably, the method further includes a step of transmitting the HARQ feedback to the BS using the first Walsh code to indicate that the UE does not transmit the SR.

Preferably, the second Walsh code is selected from one or more Walsh codes within the same PRB as that of the first Walsh code. Said one or more Walsh codes are not occupied by any UE's HARQ feedback.

Preferably, the indication is received from the BS in DCI for the UE.

According to a third aspect of the present disclosure, there is proposed a BS for identifying that a UE transmits a SR. The BS includes a determining unit, a transmitting unit, a receiving unit, and an identifying unit. The determining unit is configured to determine a first Walsh code for the UE transmitting Hybrid Automatic Repeat Request (HARQ) feedback based on a Control Channel Element (CCE) index allocated to the UE. The transmitting unit is configured to transmit to the UE an indication indicating a second Walsh code for the UE transmitting the HARQ feedback. The second Walsh code is different from the first Walsh code. The receiving unit is configured to receive the HARQ feedback from the UE. The identifying unit is configured to identify that the UE transmits the SR, if the received HARQ feedback uses the second Walsh code.

According to a fourth aspect of the present disclosure, there is proposed a UE for transmitting a SR to a BS. The UE includes a determining unit, a receiving unit, and a transmitting unit. The determining unit is configured to determine a first Walsh code for transmitting HARQ feedback based on a CCE index allocated to the UE. The receiving unit is configured to receive from the BS an indication indicating a second Walsh code for the UE transmitting the HARQ feedback. The second Walsh code is different from the first Walsh code. The transmitting unit is configured to transmit the HARQ feedback to the BS using the second Walsh code to indicate that the UE transmits the SR.

According to a fifth aspect of the present disclosure, there is proposed an apparatus for identifying at a BS that a UE transmits a SR. The apparatus includes a processor and a memory. The memory contains instructions executable by the processor whereby the apparatus is operative to: determine a first Walsh code for the UE transmitting HARQ feedback based on a CCE index allocated to the UE; transmit to the UE an indication indicating a second Walsh code for the UE transmitting the HARQ feedback, the second Walsh code being different from the first Walsh code; receive the HARQ feedback from the UE, and identify that the UE transmits the SR, if the received HARQ feedback uses the second Walsh code.

According to a sixth aspect of the present disclosure, there is proposed an apparatus for transmitting a SR at a UE to a BS. The apparatus includes a processor and a memory. The memory contains instructions executable by the processor whereby the apparatus is operative to: determine a first Walsh code for transmitting HARQ feedback based on a CCE index allocated to the UE; receive from the BS an indication indicating a second Walsh code for the UE transmitting the HARQ feedback, the second Walsh code being different from the first Walsh code; and transmit the HARQ feedback to the BS using the second Walsh code to indicate that the UE transmits the SR.

According to the present disclosure, the UE adopts a Walsh code, which is different from that determined for the UE transmitting HARQ feedback based on a CCE index allocated to the UE, for transmitting the HARQ feedback to indicate that the UE transmits a SR. Hence, the present disclosure may carry SR information on the HARQ feedback without breaking the single-carrier constraint.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates the existing HARQ feedback UL transmission mechanism.

FIG. 2 shows a flowchart of a method 200 used in a BS for identifying that a UE transmits a SR according to a first embodiment of the present disclosure.

FIG. 3 illustrates how to spread UEs' SR positions on different UL subframes.

FIG. 4 shows a flowchart of a method 400 used in a UE for transmitting a SR to a BS according to a second embodiment of the present disclosure.

FIG. 5 illustrates how UE1 transmits the SR in Example 1.

FIG. 6 illustrates how UE1 and UE2 transmit their SRs in Example 2.

FIG. 7 illustrates use of new CRC masks carrying WIS in parallel DCI blind detection.

FIG. 8 shows an example of accuracy improving by using wider DAI range.

FIG. 9 is a block diagram of a BS 900 configured according to the present disclosure.

FIG. 10 illustrates a BS 1000 according to the present disclosure.

FIG. 11 is a block diagram of a UE 1100 configured according to the present disclosure.

FIG. 12 illustrates a UE 1200 according to the present disclosure.

### DETAILED DESCRIPTION OF EMBODIMENTS

In the following detailed description, reference is made to the accompanying drawings, which form a part hereof. In the drawings, similar symbols typically identify similar components, unless context dictates otherwise. The illustrative examples or embodiments described in the detailed description, drawings, and claims are not meant to be limiting. Other examples or embodiments may be utilized, and other changes may be made, without departing from the spirit or scope of the subject matter presented here. It will be readily understood that aspects of this disclosure, as generally described herein, and illustrated in the figures, can be arranged, substituted, combined, and designed in a wide variety of different configurations, all of which are explicitly contemplated and make part of this disclosure.

As used hereinafter, it should be appreciated the term UE may be referred to as a mobile terminal, a terminal, a user terminal (UT), a wireless terminal, a wireless communication device, a wireless transmit/receive unit (WTRU), a mobile phone, a cell phone, etc. Yet further, the term UE includes MTC (Machine Type Communication) devices, which do not necessarily involve human interaction. Also, the term “BS” as used herein may be referred to as a radio base station, a NodeB or an evolved NodeB (eN B), access point, relay node, etcetera.

Control signalling from multiple UEs can be multiplexed into a single Physical Uplink Control CHannel (PUCCH) region using orthogonal Code Division Multiplexing (CDM). The PUCCH adopts CDM through different orthogonal Zadoff-Chu (ZC) sequences and Walsh codes to multiplex different UEs' information into one PRB. Each ZC sequence can support up to 4 Walsh codes. Each UE uses a unique Walsh code, which is derived according to the corresponding CCE index, for transmitting its HARQ feedback.

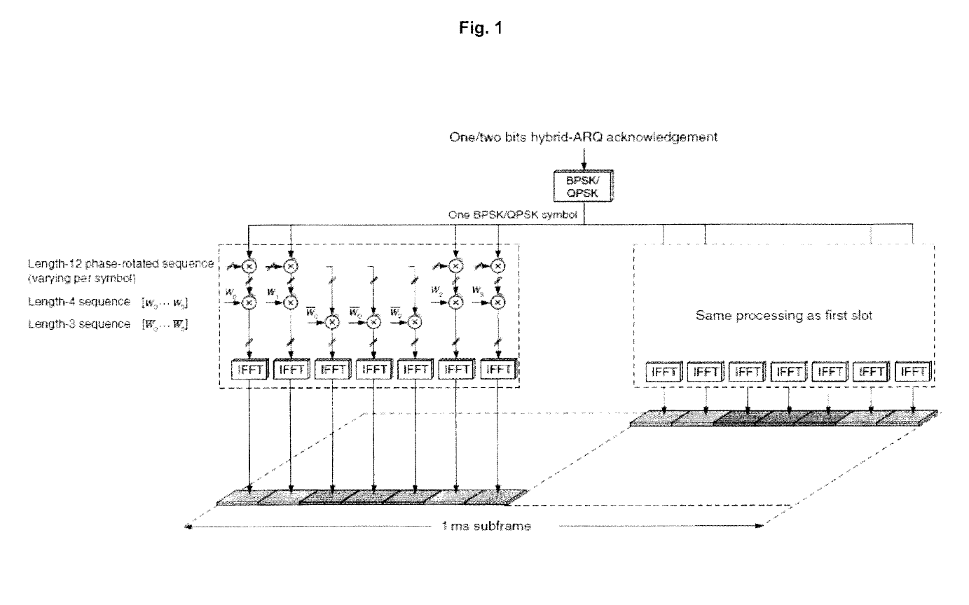

FIG. 1 illustrates the existing HARQ feedback UL transmission mechanism about the 12-size ZC sequence in frequency domain and the length-4 Walsh code in time domain.

As shown in FIG. 1, it can be seen that the HARQ feedback is modulated on 12-size ZC sequence at frequency domain, which can provide up to 12 orthogonal phase shifts. On each phase shift, it can hold at most 4 UEs' HARQ feedbacks independently by spreading frequency using length-4 Walsh code at time domain. However, due to maximum 3 Demodulation Reference Signal (DMRS) symbols limit in the middle, at most 3 UEs' HARQ feedback can be multiplexed into one ZC sequence.

Actually, not all Walsh codes are occupied in the real deployment. Instead, in most cases, more than 50% Walsh codes are idle. In this way, those idle Walsh codes at the same PRB as the original Walsh code derived from CCE index can also be used by UE to carry more information.

Table 2 shows a Walsh code definition as specified in the existing 3GPP specification (by referring to 3GPP TS 36.213, Table 5.4.1-2)

TABLE 2
Walsh code definition

| Sequence index | Orthogonal sequences |
|---|---|
| n_{oc}(nₛ) | [w(0) - - - w(N_{SF}^{PUCCH} − 1)] |
| 0 | [+1 +1 +1 +1] |
| 1 | [+1 −1 +1 −1] |
| 2 | [+1 −1 −1 +1] |
| 3 | [+1 +1 −1 −1] |

Hereunder, some embodiments will be explained in details on how to apply the idle Walsh codes in HARQ&SR multiplexing at the BS side and the UE side, respectively.

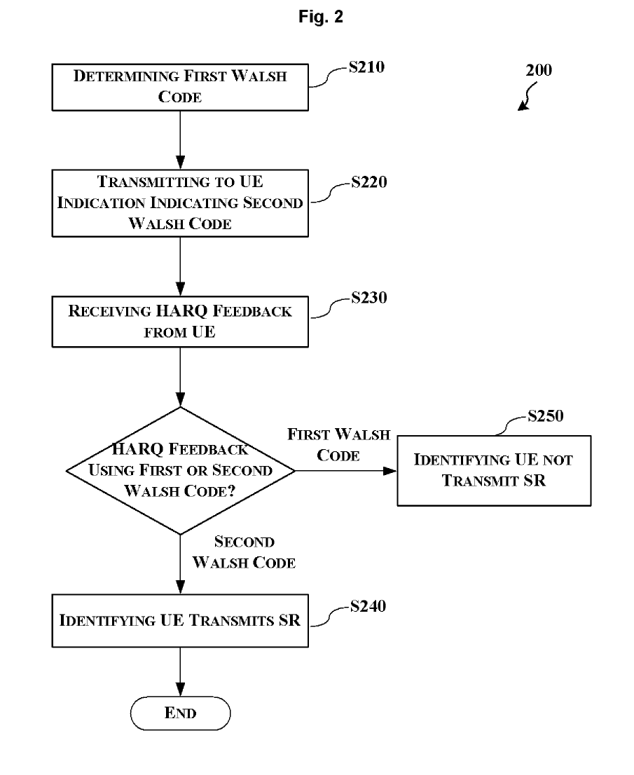

FIG. 2 shows a flowchart of a method 200 used in a BS for identifying that a UE transmits a SR according to a first embodiment of the present disclosure.

At step S210, the BS determines a first Walsh code for the UE transmitting HARQ feedback based on a CCE index allocated to the UE. In accordance with the existing 3GPP specification, the first Walsh code may be derived according to the starting CCE index of DL transmission, to which the HARQ feedback is directed.

Then, the BS may selects the second Walsh code from one or more Walsh codes within the same PRB as that of the first Walsh code (not shown). Here, the one or more Walsh codes are those not occupied by any UE's HARQ feedback. This step is optional, and it should be appreciated that the BS may obtain the second Walsh code in any appropriate manners.

At step S220, the BS transmits to the UE an indication indicating a second Walsh code for the UE transmitting the HARQ feedback. The second Walsh code is different from the first Walsh code. As an example, the indication is transmitted in DCI for the UE.

The indication here may be used to indicate an index of an unused Walsh code for the UE transmitting the SR. The indicated Walsh code should be different from the original Walsh code derived from CCE index.

At step S230, the BS receives the HARQ feedback from the UE.

At step S240, the BS identifies that the UE transmits the SR, if the HARQ feedback received at step S230 uses the second Walsh code.

The method 200 further includes an optional step S250.

At step S250, the BS identifies that the UE does not transmit the SR, if the HARQ feedback received at step S230 uses the first Walsh code.

In according to the first embodiment, the BS instructs the UE to adopt a Walsh code, which is different from that determined for the UE transmitting HARQ feedback based on a CCE index allocated to the UE, for transmitting the HARQ feedback to indicate that the UE transmits a SR. Thereby, SR information may be carried on the HARQ feedback without breaking the single-carrier constraint.

Before step S210, the method 200 may optionally include a step of: if two consecutive CCEs have been allocated to other two UEs, one or both of which are allowed to transmit a SR at the same UL subframe as the HARQ feedback, allocating to the UE CCEs inconsecutive with the two consecutive CCEs.

Since the HARQ feedback position is decided by the corresponding CCE index, the BS may try best to spread UEs' SR positions among different UL sub-frames, so as to avoid more than one UE within the same ZC phase shift group have their SR positions also configured at the same UL sub-frame.

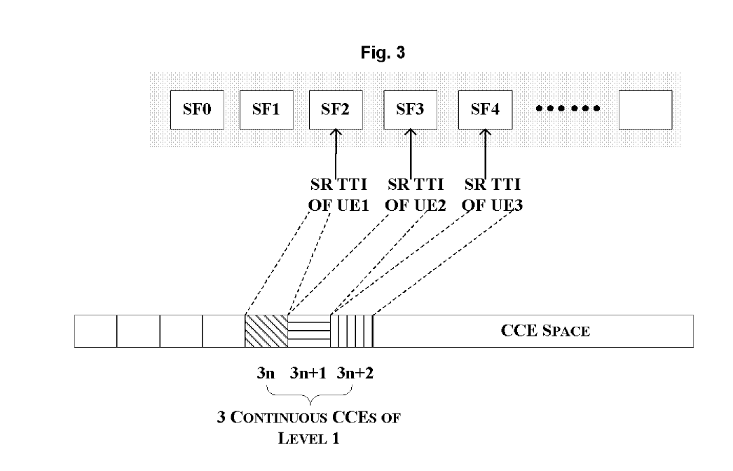

FIG. 3 illustrates how to spread UEs' SR positions on different UL subframes. Theoretically speaking, a specific ZC sequence shift in PUCCH 1a/1b can include HARQ feedback of 3 UEs whose CCE indexes are at continuous addresses 3n, 3n+1 and 3n+2 as shown in FIG. 3. As well-known, for CCE level 2 or 4or 8, since the CCE index must be aligned to an even address, a specific ZC sequence shift can only hold at most 2 UEs if one of them is at CCE level 2 or 4 or 8. In other word, only when 3 UEs all adopt CCE level 1, they can be included in same ZC sequence phase shift group.

When the BS allocates SR resources for 3 UEs, the BS should try best to spread them into different UL sub-frames if their CCE candidates of level 1 all fall into 3 consecutive addresses in Physical Downlink Control Channel (PDCCH).

For example, the BS may try best to meet the criteria: UE_{SR}+UE_{grp}<=W_{grp} at CCE allocation. UE_{SR} means the number of UEs within the same ZC phase shift group, whose SR positions happen to meet with their HARQ feedback. UE_{grp} means the number of UEs within the same ZC shift group. Apparently, UE_{SR}<=UE_{grp}<=3. W_{grp} means the maximum number of Walsh codes within one ZC phase shift group, and may be set to 4 for both normal CP and extended CP.

With such a solution, the BS can control the PUCCH slot occupation on purpose through allocating appropriate CCE position for each UE. In other words, the BS can achieve sparse Walsh code allocation pattern by scattering UEs' CCE within PDCCH. In this way, those idle Walsh codes at the same PRB as the original Walsh code derived from CCE index can also used by UEs to carry more information.

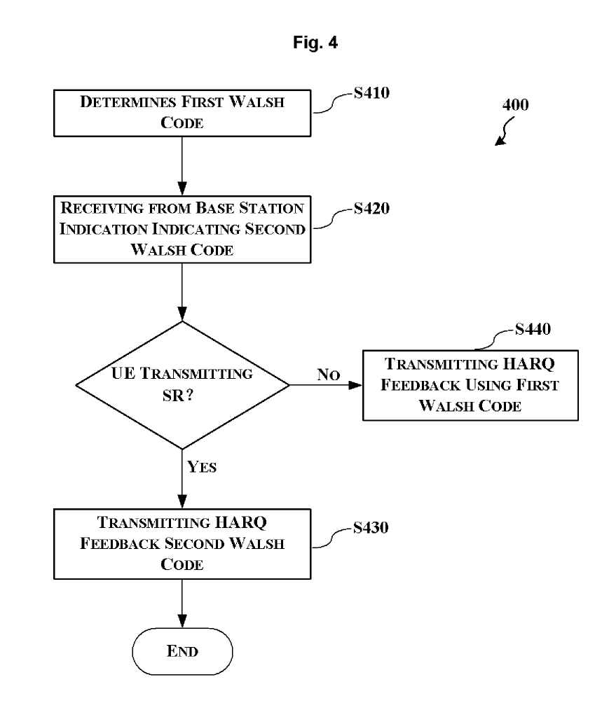

FIG. 4 shows a flowchart of a method 400 used in a UE for transmitting a SR to a BS according to a second embodiment of the present disclosure.

At step S410, the UE determines a first Walsh code for transmitting HARQ feedback based on a CCE index allocated to the UE. In accordance with the existing 3GPP specification, the first Walsh code may be derived according to the starting CCE index of DL transmission, to which the HARQ feedback is directed.

At step S420, the UE receives from the BS an indication indicating a second Walsh code for the UE transmitting the HARQ feedback. The second Walsh code is different from the first Walsh code.

For example, the second Walsh code is selected from one or more Walsh codes within the same PRB as that of the first Walsh code. Here, the one or more Walsh codes are not occupied by any UE's HARQ feedback.

For example, the indication is received from the BS in DCI for the UE.

At step S430, if the UE is to transmit the SR, the UE transmits the HARQ feedback to the BS using the second Walsh code to indicate that the UE transmits the SR.

The method 400 further includes an optional step S440.

At step S440, if the UE is not to transmit the SR, the UE transmits the HARQ feedback to the BS using the first Walsh code to indicate that the UE does not transmit the SR.

In according to the second embodiment, the UE may adopt a Walsh code, which is different from that determined for the UE transmitting HARQ feedback based on a CCE index allocated to the UE, for transmitting the HARQ feedback to indicate that the UE transmits a SR. Thereby, SR information may be carried on the HARQ feedback without breaking the single-carrier constraint.

Hereunder, examples of multiplexing HARQ and SR will be explained in details by employing 2 types of relationship between UE_{grp} and UE_{SR} on a basis of the Walsh code definition as listed in Table 2.

### Example 1

### Type 1/3 (UE_{grp}=3, UE_{SR}=1)

This example relates to a scenario where 3 UEs (e.g., UE1, UE2, and UE3 in FIG. 5) with adjacent CCE indexes are packed into same ZC sequence shift group, and there is at most only one UE (e.g., UE1 in this example) having a SR to transmit.

FIG. 5 illustrates how UE1 transmits the SR in this example. As shown in FIG. 5, UE1's original HARQ position is at walsh00, and UE2 and UE3 have respective original HARQ positions at Walsh01 and Walsh02, respectively. The unused walsh03 is also allocated to UE1. Then, if UE1 has a SR to transmit, UE1 may transmit its HARQ feedback using walsh03 instead of walsh00. When receiving UE1's HARQ feedback on walsh03, the BS will not only get the HARQ feedback, but also identify that UE1 transmits the SR.

In this example, UE1 can indicate its SR to the BS by changing the Walsh code for transmitting the HARQ feedback.

### Example 2

### Type 2/2 (UE_{grp}=2, UE_{SR}=2)

This example is related to a scenario where 2 UEs (e.g., UE1 and UE2 in FIG. 6) are packed into the same ZC sequence shift group, and these two UEs both need to transmit SR.

FIG. 6 illustrates how UE1 and UE2 transmit their SRs in this example. As shown in FIG. 6, UE1's original HARQ position is at walsh00, and UE2's original HARQ position is at walsh01. Accordingly, UE1 will use walsh02 instead of the original walsh00 as the second Walsh code to transmit HARQ feedback, and UE2 will use walsh03 instead of walsh01 as the second Walsh code to transmit HARQ feedback. When receiving UE1's HARQ feedback on walsh02, the BS will not only get the HARQ feedback, but also identify that UE1 transmits the SR. Similarly, when receiving UE2's HARQ feedback on walsh03, the BS will not only get the HARQ feedback, but also identify that UE2 transmits the SR.

In this example, both UE1 and UE2 can indicate their SRs to the BS by changing respective Walsh codes for transmitting HARQ feedback.

Hereunder, exemplary signaling of the indication occurring in the first and second embodiments will be illustrated in details.

In accordance with the present disclosure, WIS (Walsh code Index for SR multiplexing) is added into DL DCI to signal the indication. Specifically, WIS is a 2 bits indicator used to indicate to UE the index of the second Walsh code for multiplexing of SR and HARQ feedback. However, simply adding 2 bits WIS into DL DCI will increase a size of DCI, which will impact the successful rate of DCI decoding at the UE side. To keep the same size of DCI, the present disclosure may take another action to move DAI out of DCI. This may release 2 bits for WIS.

In TDD-LTE, the most DCI formats (DCI1A/1/2/2A . . . ) include 2 bits DAI used to indicate the index of DL transmission during bundling window (by referring to 3GPP TS 36.212-860: “Evolved Universal Terrestrial Radio Access (E-UTRA); Multiplexing and channel coding”). The existing 2 bits DAI can only indicate at most 4 DL transmissions during the bundling window. However, some TDD configuration currently allows for more than 4 DL sub-frames during the bundling window, which exceeds the 2 bits DAI value range and introduces the ambiguous interpretation of DAI at UE side.

To release DCI room for WIS and provide the broader value range the present disclosure moves the 2 bits of DAI from DCI into the higher bits of CRC mask.

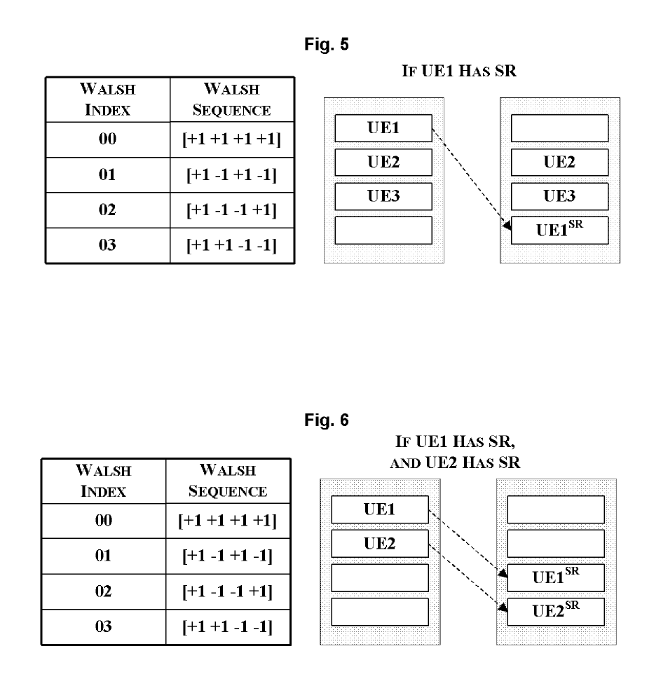

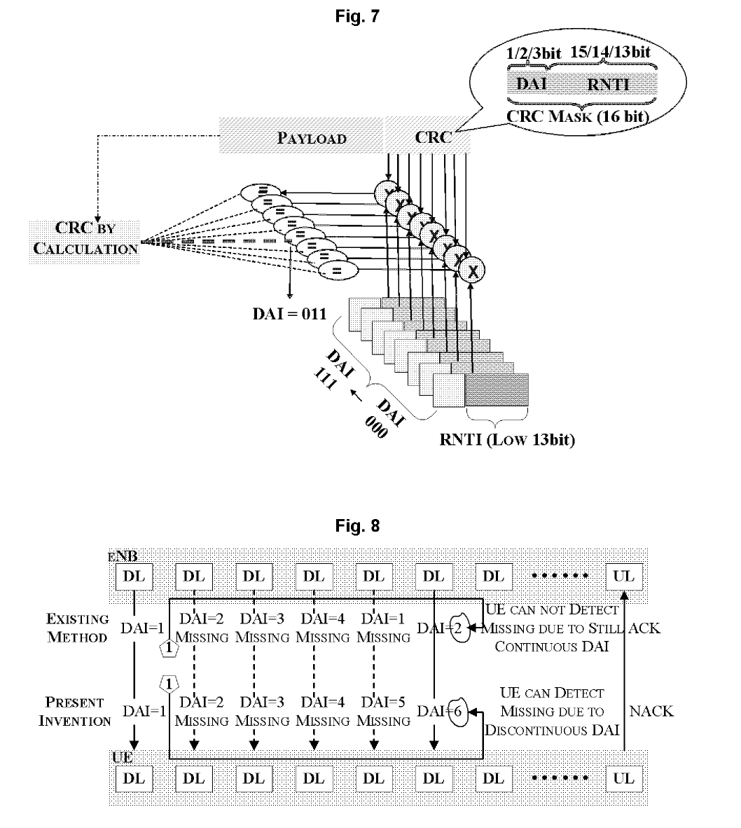

FIG. 7 illustrates the use of new DAI-generating CRC masks in parallel DCI blind detection using.

In accordance with the existing 3GPP specification, a 16 bits CRC, which also implicitly provides UE specific identification through masking with UE's RNTI, is appended to the end of DCI payload. Although 16 bits RNTI theoretically can support up to 65535 UEs per cell, the real site actually must not accommodate so many UEs due to other limits, such as RB resources, eNB implementation complexity, mutual interference, etc. Thus, the capacity per cell usually stays at hundreds level, at most at thousands level, which means that the 16 bits RNTI actually exceeds the actual needs greatly.

As shown in FIG. 7, the RNTI mask length is shortened to release out some bits for DAI. This can be implemented through careful UE RNTI allocation. Putting DAI in higher bits of RNTI is due to CRC itself characteristics that the higher bits are more robust to resist wrong payload bit interference compared with those lower bits. From eNB perspective, the whole RNTI space (0-65535) is divided into several groups, each having a fixed number of RNTIs. When UE performs random access, eNB guarantees only one RNTI from each group assigned to UE.

After relocating to CRC mask, the DAI is no longer constrained by DCI room and can get the more flexibility to adjust its size. Instead of the existing fixed 2 bits, the DAI size can be adjusted to 1, 2 or 3 bits based on TDD DL:UL configuration mode. The following Table 3 shows a relationship between DAI size and TDD configuration mode. The adjustable DAI as the higher bits together with UE RNTI as the lower bits construct the whole 16bits CRC mask used for UE to uniquely identify its own DCI.

TABLE 3
Relationship between DAI size and TDD configuration mode

| TDD configuration | DAI | RNTI group | RNTI number |
|---|---|---|---|
| mode | size | number | per group |
| Mode 1 (3:2) | 2 | 16384 | 4 |
| Mode 2 (4:1) | 2 | 16384 | 4 |
| Mode 3 (7:3) | 3 | 8192 | 8 |
| Mode 4 (8:2) | 3 | 8192 | 8 |
| Mode 5 (9:1) | 3 | 8192 | 8 |
| Mode 6 (5:5) | 1 | 32768 | 2 |

When UE receives the DCI, it hasn't known the DAI in advance, so UE needs to try all possible DAI values together with its own RNTI to construct complete CRC masks to decode DCI as shown in FIG. 7. If CRC is matched, the correct DAI is just recognized and its own DCI is available. In the real implementation, due to the independence among multiple possible DAIs, the DCI decoding attempts based on different DAI-generating CRC masks can be performed simultaneously, so the total DCI blind decoding time still remains same as the existing solution.

Through fully utilizing the excess RNTI large space and adjustable RNTI grouping mechanism, the present disclosure successfully hides DAI into CRC mask without increasing total DCI blind detection time. Furthermore, after moving DAI from DCI to CRC mask, the DAI size is no longer constrained by DCI size. So, DAI size can be dynamically adjusted from 1-3 bits according to actual TDD configuration mode. Hence, it can provide more accurate indication of DL transmission index than the existing 3GPP standard.

The eNB sets the DAI of current DL transmission according to following Table 4 with DAI size set by referring to 3GPP TS 26.213, Table 7.3-X.

TABLE 4
DAI value setting (DAI size: 3 bits)

| DAI field in RNTI | Number of subfrannes |
|---|---|
| (MSB . . . LSB) | with PDSCH transmission |
| 000 | 0 or 8 |
| 001 | 1 or 9 |
| 002 | 2 |
| 003 | 3 |
| 004 | 4 |
| 005 | 5 |
| 006 | 6 |
| 007 | 7 |

From the above Table 4, it can be clearly seen that the ambiguity of DAI is greatly decreased compared with the existing solution and the DL transmission missing can be more easily detected.

FIG. 8 shows an example of accuracy improvement by using wider DAI range.

As shown in FIG. 8, 4 DL sub-frames are missed. However, UE can't detect this using the existing method in the prior art because the DAI behind the 4 DL sub-frames still seems consecutive. Rather, the present disclosure may extend the limit to 8. In this case, as long as no more than 8 DL sub-frames are lost, UE always can reply correct HARQ feedback to eNB. Considering the very low probability of consecutive 8 DL sub-frames missing, the 3 bits DAI can almost avoid the DAI ambiguity.

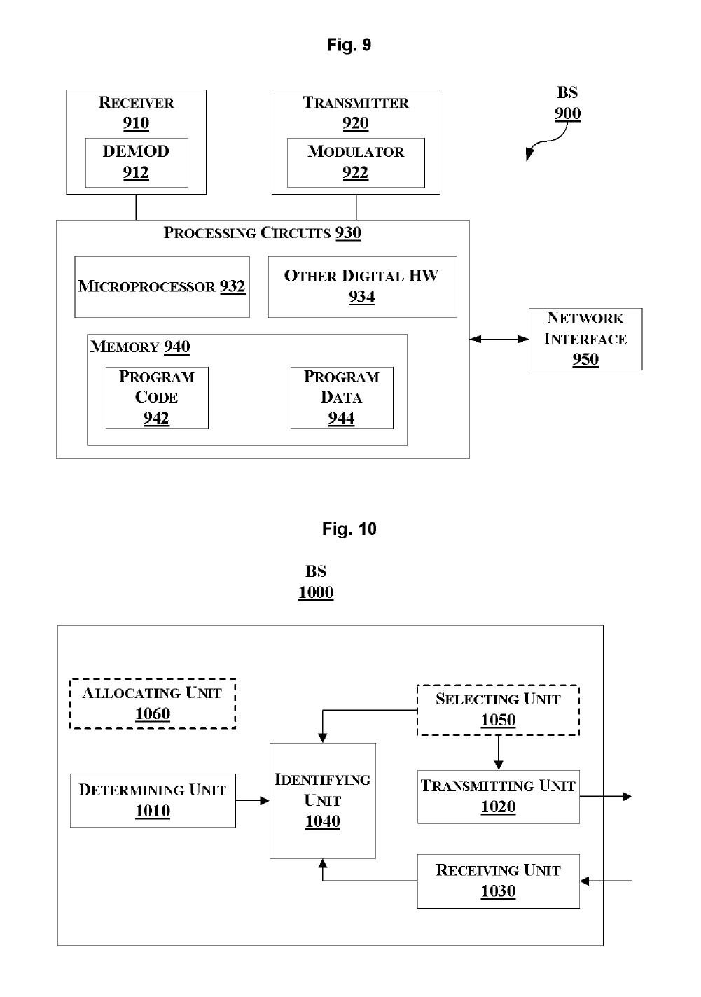

FIG. 9 is a block diagram of a BS 900 for identifying that a UE transmits a SR according to a third embodiment of the present disclosure. In particular, the BS 900 may be configured to implement the method as illustrated in FIG. 2, or variants thereof.

As shown, the BS 900 includes a receiver 910, which includes at least two antennas and various other radio-frequency components (not shown) and a demodulator 912. The receiver 910 receives radio signals received from one or more wireless BS, and processes the signals by using known radio processing and signal processing techniques, to convert the received radio signals into digital samples for processing circuits 930. The processing circuits 930 extract data from signals received via the receiver 910 and generate information for transmission to the UE via transmitter 920. Like the receiver 910 and the demodulator 912, the transmitter 920 and modulator 922 use known radio processing and signal processing components and techniques, typically according to one or more telecommunications standards, and are configured to format digital data and generate and condition a radio signal, from that data, for transmission over the air.

The processing circuits 930 include one or several microprocessors 932, digital signal processors, and the like, as well as other digital hardware 934 and memory 940. The memory 940, which may include one or several types of memory such as read-only memory (ROM), random-access memory (RAM), cache memory, flash memory devices, optical storage devices, etc., stores program code 942 for executing one or more telecommunications and/or data communications protocols and for carrying out one or more of the techniques for signaling SR transmission-related information described herein. Memory 940 further stores program data 944 as well as buffered traffic data received from U Es and from network interface 950, and also stores various parameters, predetermined threshold values, and/or other program data for controlling the general operation of the BS 900.

In some embodiments, the processing circuits 930, using appropriate program code 942 stored in the memory 940, are configured to implement one or more methods or steps described above. Of course, not all of the steps of these methods are necessarily performed in a single microprocessor or even in a single module.

FIG. 10 presents a block diagram of a BS 1000 configured to carry out one or several of the SR identifying techniques discussed herein according to the present disclosure. The BS 1000 may have a physical configuration like that illustrated in FIG. 9, and may be implemented as hardware, software or a combination of hardware and software. In any case, however, the BS 1000 is configured to implement at least four functions, which are pictured in FIG. 10 as a determining unit 1010, a transmitting unit 1020, a receiving unit 1030, and an identifying unit 1040. For example, the determining unit 1010 and the identifying unit 1040 may be embodied in the processing circuits 930 as shown in FIG. 9. Similarly, the transmitting unit 1020 and the receiving unit 1030 may be embodied in the transmitter 920 and the receiver 910 as shown in FIG. 9, respectively.

The determining unit 1010 determines a first Walsh code for the UE transmitting HARQ feedback based on a CCE index allocated to the UE.

The transmitting unit 1020 transmits to the UE an indication indicating a second Walsh code for the UE transmitting the HARQ feedback. Herein, the second Walsh code is different from the first Walsh code. For example, the transmitting unit 1020 transmits the indication in DCI for the UE.

The receiving unit 1030 receives the HARQ feedback from the UE.

The identifying unit 1040 identifies that the UE transmits the SR, if the HARQ feedback received by the receiving unit 1030 uses the second Walsh code. Optionally, the identifying unit 1040 identifies that the UE does not transmit the SR, if the received HARQ feedback uses the first Walsh code.

Optionally, the BS 1000 may further include a selecting unit 1050, which may be embodied in, e.g., the processing circuits 930 as shown in FIG. 9. The selecting unit 1050 selects the second Walsh code from one or more Walsh codes within the same PRB as that of the first Walsh code. Herein, the one or more Walsh codes are those not occupied by any UE's HARQ feedback.

Optionally, the BS 1000 may further include an allocating unit 1060. For example, the allocating unit 1060 may be embodied in the processing circuits 930 as shown in FIG. 9. The allocating unit 1060 is configured to:
if two consecutive CCEs have been allocated to other two UEs, one or both of which are allowed to transmit a SR at the same UL subframe as the HARQ feedback, allocate to the UE CCEs inconsecutive with the two consecutive CCEs.

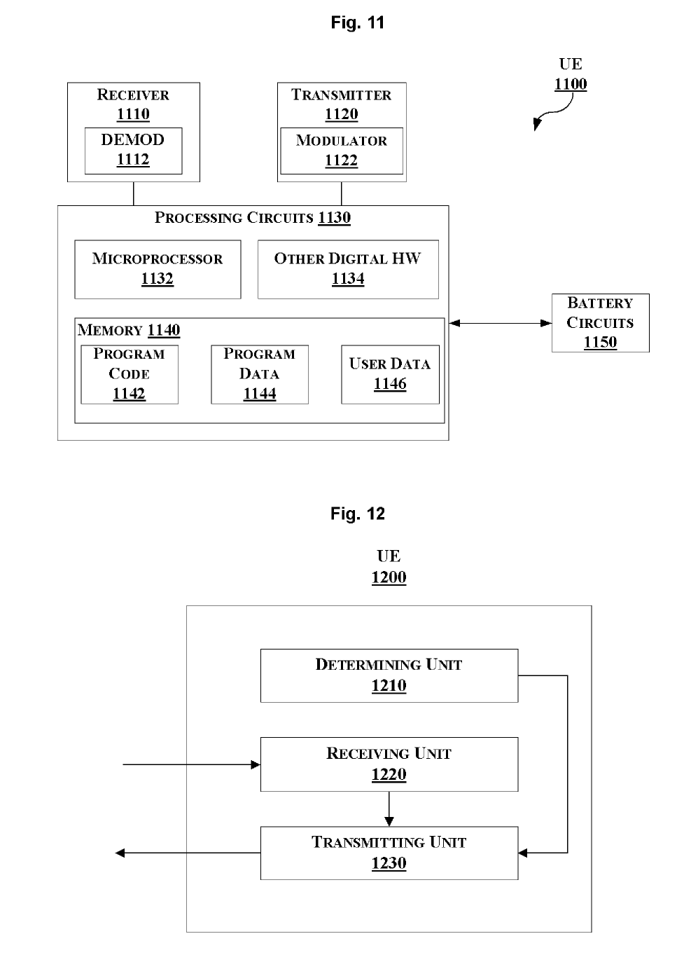

FIG. 11 is a block diagram of a UE 1100 for transmitting a SR to a BS according to a fourth embodiment of the present disclosure. In particular, UE 1100 may be configured to participate in the method illustrated in FIG. 4, or variants thereof.

As shown, the UE 1100 includes a receiver 1110, which includes at least two antennas and various like radio-frequency components (not shown) and a demodulator 1112. The receiver 1110 receives radio signals received from one or more BSs, and processes the signals by using known radio processing and signal processing techniques, for the processor circuits 1130. The processing circuits 1130 extract data from signals received via the receiver 1110 and generate information for transmission to a corresponding eNB via the transmitter 1120. Like the receiver 111 0 and the demodulator 1112, the transmitter 1120 and the modulator 112 use known radio processing and signal processing components and techniques, typically according to a particular telecommunications standard such as LTE and LTE-A (Advanced), and are configured to format digital data and generate and condition a radio signal for transmission over the air.

The processing circuits 1130 include one or several microprocessors 1132, digital signal processors, and the like, as well as other digital hardware 1134 and memory 1140. The memory 1140, which includes one or several types of memory such as read-only memory (ROM), random-access memory (RAM), cache memory, flash memory devices, optical storage devices, etc., stores program code 1142 for executing one or more telecommunications and/or data communications protocols and for carrying out one or more of the techniques described herein. The memory 1140 further stores program data 1144, user data 1146 received from the BS and to be transmitted to the BS, and also stores various parameters, pre-determined threshold values, and/or other program data for controlling the operation of the UE 1100. The UE 1100 includes various other features that are not shown, in addition to the battery circuits 1150 pictured in FIG. 11; these features, such as user interface circuitry, positioning circuits, and the like, are well known to those skilled in the art and are therefore not illustrated.

In various embodiments, the processing circuits 1130, using appropriate program code 1142 stored in the memory 1140, are configured to implement one or more methods or steps described above. Of course, not all of the steps of these techniques are necessarily performed in a single microprocessor or even in a single module.

Thus, FIG. 12 presents a block diagram of a UE 1200 configured to carry out one or several of the SR transmitting techniques described herein. The UE 1200 may have a physical configuration like that illustrated in FIG. 11, and may be implemented as hardware, software or a combination of hardware and software. In any case, however, the UE 1200 is configured to implement at least three functions, which are pictured in FIG. 12 as a determining unit 1210, a receiving unit 1220, and a transmitting unit 1230. For example, the determining unit 1210 may be embodied in the processing circuits 1130 as shown in FIG. 11. Similarly, the receiving unit 1220 and the transmitting 1230 may be embodied in the receiver 1110 and the transmitter 1120 as shown in FIG. 11, respectively.

The determining unit 1210 determines a first Walsh code for transmitting HARQ feedback based on a CCE index allocated to the UE.

The receiving unit 1220 receives from the BS an indication indicating a second Walsh code for the UE transmitting the HARQ feedback. Herein, the second Walsh code is different from the first Walsh code. For example, the receiving unit 1220 receives the indication from the BS in DCI for the U E.

For example, the second Walsh code is selected from one or more Walsh codes within the same PRB as that of the first Walsh code. The one or more Walsh codes here are those not occupied by any UE's HARQ feedback.

The transmitting unit 120 transmits the HARQ feedback to the BS using the second Walsh code to indicate that the UE transmits the SR. Optionally, the transmitting 1230 transmits the HARQ feedback to the BS using the first Walsh code to indicate that the UE does not transmit the SR.

It should be noted that two or more different units in this disclosure may be logically or physically combined. For example, the determining unit 1010 and the identifying unit 1040 may be combined as one single unit, e.g., the processing circuits 930 in FIG. 9.

Although the present technology has been described above with reference to specific embodiments, it is not intended to be limited to the specific form set forth herein. For example, the embodiments presented herein are not limited to the existing LTE system; rather they are equally applicable to new communication standards defined in future. The technology is limited only by the accompanying claims and other embodiments than the specific above are equally possible within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Finally, reference signs in the claims are provided merely as a clarifying example and should not be construed as limiting the scope of the claims in any way.

1. A method used in a Base Station (BS) for identifying that a User Equipment (UE) transmits a Scheduling Request (SR), the method comprising:
determining a first Walsh code for the UE transmitting Hybrid Automatic Repeat Request (HARQ) feedback based on a Control Channel Element (CCE) index allocated to the UE;
transmitting to the UE an indication indicating a second Walsh code for the UE transmitting the HARQ feedback, the second Walsh code being different from the first Walsh code;
receiving the HARQ feedback from the UE; and
identifying that the UE transmits the SR if the received HARQ feedback uses the second Walsh code.

2. The method according to claim 1, further comprising:
identifying that the UE does not transmit the SR if the received HARQ feedback uses the first Walsh code.

3. The method according to claim 1, further comprising:
selecting the second Walsh code from at least one Walsh code within the same Physical Resource Block (PRB) as that of the first Walsh code, said at least one Walsh code not being occupied by any UE's HARQ feedback.

4. The method according to claim 1, wherein the indication is transmitted in Downlink Control Information (DCI) for the UE.

5. The method according to claim 1, the method further comprises comprising:
before determining the first Walsh code:
if two consecutive CCEs have been allocated to other two UEs, at least one of which is allowed to transmit a SR at the same UL subframe as the HARQ feedback, allocating to the UE CCEs inconsecutive with the two consecutive CCEs.

6. A method used in a User Equipment (UE) for transmitting a Scheduling Request (SR) to a Base Station (BS), the method comprising:
determining a first Walsh code for transmitting Hybrid Automatic Repeat Request (HARQ) feedback based on a Control Channel Element (CCE) index allocated to the UE;
receiving from the BS an indication indicating a second Walsh code for the UE transmitting the HARQ feedback, the second Walsh code being different from the first Walsh code; and
transmitting the HARQ feedback to the BS using the second Walsh code to indicate that the UE transmits the SR.

7. The method according to claim 6, further comprising:
transmitting the HARQ feedback to the BS using the first Walsh code to indicate that the UE does not transmit the SR.

8. The method according to claim 6, wherein the second Walsh code is selected from at least one Walsh code within the same Physical Resource Block (PRB) as that of the first Walsh code, said at least one Walsh code not being occupied by any UE's HARQ feedback.

9. The method according to claim 6, wherein the indication is received from the BS in Downlink Control Information (DCI) for the UE.

10. A Base Station (BS) for identifying that a User Equipment (UE) transmits a Scheduling Request (SR), the Base Station comprising:
a determining unit configured to determine a first Walsh code for the UE transmitting Hybrid Automatic Repeat Request (HARQ) feedback based on a Control Channel Element (CCE) index allocated to the UE;
a transmitting unit configured to transmit to the UE an indication indicating a second Walsh code for the UE transmitting the HARQ feedback, the second Walsh code being different from the first Walsh code;
a receiving unit configured to receive the HARQ feedback from the UE; and
an identifying unit configured to identify that the UE transmits the SR if the received HARQ feedback uses the second Walsh code.

11. The BS according to claim 10, wherein the identifying unit is further configured to:
identify that the UE does not transmit the SR if the received HARQ feedback uses the first Walsh code.

12. The BS according to claim 10, further comprising:
a selecting unit configured to select the second Walsh code from at least one Walsh code within the same Physical Resource Block (PRB) as that of the first Walsh code, said at least one Walsh code not being occupied by any UE's HARQ feedback.

13. The BS according to claim 10, wherein the transmitting unit is configured to transmit the indication in Downlink Control Information (DCI) for the UE.

14. The BS according to claim 10, further comprising an allocating unit configured to:
if two consecutive CCEs have been allocated to other two UEs, at least one of which is allowed to transmit a SR at the same UL subframe as the HARQ feedback, allocate to the UE CCEs inconsecutive with the two consecutive CCEs.

15. A User Equipment (UE) for transmitting a Scheduling Request (SR) to a Base Station (BS), the User Equipment comprising:
a determining unit configured to determine a first Walsh code for transmitting Hybrid Automatic Repeat Request (HARQ) feedback based on a Control Channel Element (CCE) index allocated to the UE;
a receiving unit configured to receive from the BS an indication indicating a second Walsh code for the UE transmitting the HARQ feedback, the second Walsh code being different from the first Walsh code; and
a transmitting unit configured to transmit the HARQ feedback to the BS using the second Walsh code to indicate that the UE transmits the SR.

16. The UE according to claim 15, wherein the transmitting unit is further configured to transmit the HARQ feedback to the BS using the first Walsh code to indicate that the UE does not transmit the SR.

17. The UE according to claim 15, wherein the second Walsh code is selected from at least one Walsh code within the same Physical Resource Block (PRB) as that of the first Walsh code, said at least one Walsh code not being occupied by any UE's HARQ feedback.

18. The UE according to claim 15, wherein the receiving unit is configured to receive the indication from the BS in Downlink Control Information (DCI) for the UE.

19. The method according to claim 2, further comprising:
selecting the second Walsh code from at least one Walsh code within the same Physical Resource Block (PRB) as that of the first Walsh code, said at least one Walsh code not being occupied by any UE's HARQ feedback.

20. The method according to claim 2, the method further comprising:
before determining the first Walsh code:
if two consecutive CCEs have been allocated to other two UEs, at least one of which is allowed to transmit a SR at the same UL subframe as the HARQ feedback, allocating to the UE CCEs inconsecutive with the two consecutive CCEs.
